(19) United States
(12) Patent Application Publication
(10) Pub. No.: US 2026/0164372 A1
(43) Pub. Date: Jun. 11, 2026

(54) TIME SYNCHRONIZATION IN A WIRELESS NETWORK

(71) Applicant: HEWLETT PACKARD ENTERPRISE DEVELOPMENT LP, Spring, TX (US)

(72) Inventor: Xuguang Jia, Beijing (CN)

(21) Appl. No.: 18/976,724

(22) Filed: Dec. 11, 2024

(51) Int. Cl. H04W 56/00

(52) U.S. Cl. CPC H04W 56/00

(57) ABSTRACT

An example method and a network controller are presented to aid in time-synchronizing networking resources. The network controller may create a network domain comprising a set of candidate network resources based on a time-sensitive networking demand of the set of candidate network resources. Further, the network controller may select a reference clock resource for the network domain from a set of candidate networking resources based on respective time-synchronization capabilities. Furthermore, the network controller may determine target times corresponding to affiliate networking resources based on respective predefined network delays relative to the reference clock resource, wherein the affiliate networking resources are candidate networking resources of the network domain other than the reference clock resource. After the target times are calculated, the network controller may cause the reference clock resource to transmit the target times to the affiliate networking resources.

### BACKGROUND

The wireless-fidelity (Wi-Fi) standards such as the Institute of Electrical and Electronics Engineers (IEEE) 802.11be (also known as Wi-Fi 7) generally promise to significantly boost the speed and stability of wireless connections while offering lower latency and seamlessly manage an increased number of connections compared to the prior Wi-Fi Standards. In today's high-tech world, industries like industrial automation, automotive, and real-time audio/video streaming demand time-synchronization, minimal jitter, and low latency. These applications require increased time precision and synchronization among the networking devices. However, traditional Wi-Fi networks struggle with challenges like variable transmission delays, interference, and the mobility of devices, making high-precision time synchronization difficult.

### BRIEF DESCRIPTION OF THE DRAWINGS

One or more examples in the present disclosure are described in detail with reference to the following Figures. The Figures are provided for purposes of illustration only and merely depict examples.

FIG. 1 depicts an example networked system in which various of the examples presented herein may be implemented.

FIG. 2 depicts a block diagram of a network controller for time synchronizing among networking resources in a network infrastructure.

FIG. 3 depicts a flowchart of an example method for time synchronizing among networking resources in a network infrastructure.

FIG. 4 depicts a flowchart of another example method for time synchronizing among networking resources in a network infrastructure.

FIG. 5 depicts a block diagram of an example computing system.

The Figures are not exhaustive and do not limit the present disclosure to the precise form disclosed.

### DETAILED DESCRIPTION

Time-sensitive networks refer to the type of networks that demand accurate time synchronization among the networking nodes present in the network to enable time-sensitive applications. The networking nodes in such time-sensitive networks are configured to have the same understanding of the time, and data packets need to be delivered within a predefined time budget and with the delay jitter being low. However, due to factors such as variable transmission delays, interference, and mobility of networking nodes, the time-sensitive networks may face challenges in achieving high-precision time synchronization among the networking nodes.

Traditional methods of achieving time synchronization entail using management frames such as the beacon frames to coordinate access to wireless channels by client devices in the network. Typically, these beacon frames are sent by an access point (AP) to the client devices periodically (e.g., usually every 102.4 milliseconds) including information about the network and the AP's Timing Synchronization Function (TSF) timer value. Each client device maintains a TSF timer, and the client device receives a beacon frame, it overwrites its TSF timer with the value in the frame if it is later. However, such beacon-based time synchronization generally requires complex hardware to achieve high-precision time synchronization required by Time-Sensitive Networking (TSN) applications.

With the advent of Wi-Fi 7 and the upcoming Wi-Fi 8 standards, there is a growing need for efficient time synchronization mechanisms in wireless networks to meet these stringent requirements. For instance, in certain wireless local area network (WLAN) implementations with the provision for the Multi-Link Operation (MLO), a given networking device (e.g., AP) may be configured with a multi-link device (MLD) capability wherein one of the radios of the given networking device is configured to function as a main AP (MAP) and the rest of the radios of the given networking device may be configured to function as affiliated APs. In such a configuration with the MLD capability, the given networking device may be operated in a Non-Simultaneous Transmit and Receive (NSTR) mode. In the NSTR mode, receiving and sending operations are not simultaneously performed on any radio. At a single time, all radios can only receive data, or all radios can transmit data. To operate the networking device in the NSTR mode, TSF synchronization across different radios is required.

Further, in another known implementation (also known as a unified MLD), several networking devices with multiple radios may form a multi-link device group. In such a multi-link device group, one of the radios may be configured to function as a MAP and the rest of the radios in the multi-link device group may be configured to function as affiliated APs. In such a WLAN implementation, it is useful to have TSF synchronization across these radios. Moreover, the future IEEE Standard such as Wi-Fi 8 is expected to introduce more advanced multi-AP coordination, which may inherently require TSF synchronization to ensure seamless operation and coordination among multiple APs.

Certain known time-synchronization techniques such as Precision Time Protocol (PTP) and generalized PTP (gPTP) entail calculating a delay between each device pair, to synchronize timing between the devices in each device pair. For example, if eight networking devices need to be time synchronized, in the PTP or gPTP techniques, one of the eight networking devices may be selected as a reference clock resource, and the rest of the networking devices may function as affiliates. The reference clock resource may calculate a delay between the reference clock resource and each affiliate separately, and then each affiliate may be time-synchronized with the clock individually. As the number of networking devices may grow in the WLAN, such a traditional time-synchronization process may consume increased airtime and bandwidth impacting airtime available for useful data communication. In particular, as it is apparent, calculating the delay between an increased number of networking device pairs and then performing time-synchronization with each affiliate individually may take a considerably longer time. Therefore, there is a need to enhance the time-synchronization process.

In examples consistent with the teachings of this disclosure, a network controller is proposed that may be configured to efficiently time-synchronize the networking resources located in a network infrastructure while reducing the overall time required for synchronization and improving available airtime for quality data communication. In particular, the network controller may achieve increased efficiency in time synchronization by utilizing available results of other ranging techniques and multi-link device capabilities of certain networking resources present in the network infrastructure. The proposed network controller may be deployed within the network infrastructure or outside the network infrastructure in a cloud infrastructure. The term networking resource used herein may refer to a communication unit of a networking device, such as a router, a wireless access point, and the like. The communication unit may be a radio circuit (also commonly referred to as a radio of a networking device). In certain other examples, the term networking resource may refer to the networking device itself.

In some examples, the proposed network controller may first select a network domain within the network infrastructure that may need precise time synchronization. In particular, the network controller may select a set of candidate networking resources or an area within the network infrastructure as the network domain based on a Time-Sensitive Networking (TSN) demands of a plurality of networking resources in the network infrastructure. The TSN demand may be determined based on one or more of a multi-access point (AP) coordination demand, an NSTR demand, or a TSN demand.

Further, to synchronize the timing among the candidate networking resources in the network domain, the network controller may select a reference clock resource from the candidate networking resources based on respective time-synchronization capabilities. Examples of the time-synchronization capabilities that the network controller may consider in selecting the reference clock resource may include, one or more of the presence of a predefined clock resource, a ranging capability, or an MLD capability. In certain examples, the network controller may assign a clock priority to the candidate networking resources based on the respective time-synchronization capabilities and use such clock priorities to select one of the candidate networking resources as the reference clock resource. The remaining candidate networking resources are referred to as affiliate networking resources. Then, the network controller may time synchronize the affiliate networking resources with the reference clock resource. In particular, the network controller may determine target times corresponding to the affiliate networking resources based on the respective predefined network delays relative to the reference clock resource and cause the reference clock resource to transmit the target times to the affiliate networking resources.

As will be appreciated, in some implementations, the reference clock resource may have already calculated the network delays corresponding to the affiliated networking resources as a result of the execution of one or more ranging processes such as a Fine Timing Measurement (FTM) or Round-Trip Time (RTT) measurement. The network controller may use such pre-calculated network delays as the predefined network delays in time-synchronizing the affiliated networking resources with the reference clock resource. As a result, unlike the existing time-synchronization techniques such as PTP or gPTP that entail re-calculating a delay between each device pair (e.g., a designated reference clock resource and the other networking device in the PTP/gPTP process), the proposed time synchronization by the network controller saves significant time by using the already available/precalculated delay values (i.e., the predefined network delay). Furthermore, the reference clock resource is configured to be used as a main-AP (MAP) of the MLD to distribute the target times to the respective affiliated networking resources simultaneously, thereby saving another considerable time that the traditional PTP and gPTP techniques may spend in time-synchronizing each networking resource individually.

The following detailed description refers to the accompanying drawings. It is to be expressly understood that the drawings are for the purpose of illustration and description only. While several examples are described in this document, modifications, adaptations, and other implementations are possible. Accordingly, the following detailed description does not limit disclosed examples. Instead, the proper scope of the disclosed examples may be defined by the appended claims.

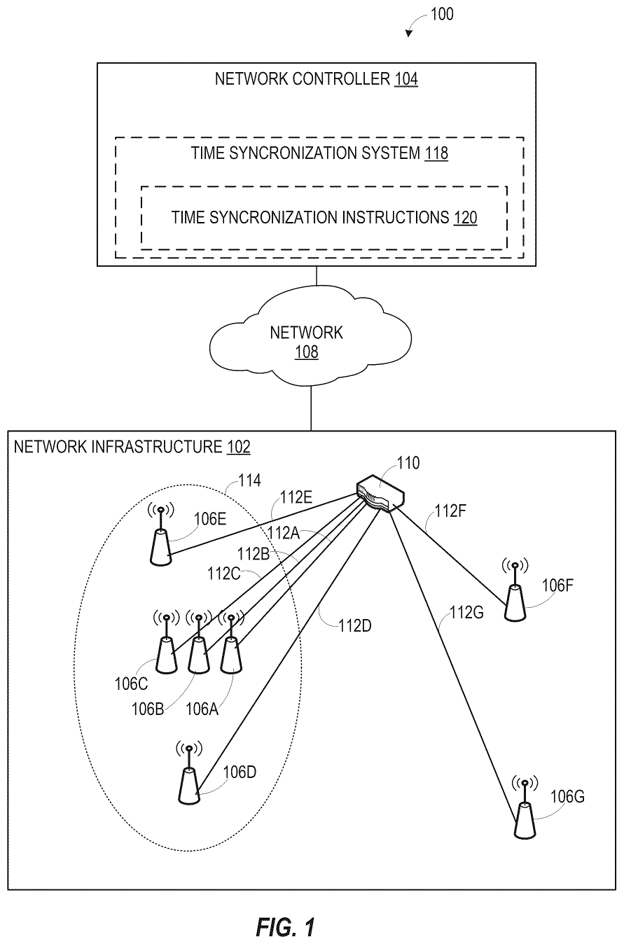

Before describing examples of the disclosed systems and methods in detail, it is useful to describe an example network installation with which these systems and methods might be implemented in various applications. FIG. 1 depicts an example networked system 100 in which various of the examples presented herein may be implemented. The networked system 100 may be implemented for any setup, for example, in a home setup or an organization, such as a business, educational institution, governmental entity, healthcare facility, or other organization. The networked system 100 may include a network infrastructure 102, or both the network infrastructure 102 and a network controller 104. In FIG. 1, although the network controller 104 is shown external to the network infrastructure 102, in some examples, the network controller 104 may be a part of the network infrastructure 102. In certain examples, the networking devices (e.g., access points, controllers, routers, etc.) deployed in the network infrastructure 102 may be configured to implement the functionalities of the network controller 104.

In some examples, the network controller 104 may communicate with the network infrastructure 102 via a network 108 which may be a public or private network, such as the Internet, or another communication network to allow connectivity between the network infrastructure 102 and the network controller 104. The network 108 may include third-party telecommunication lines, such as phone lines, broadcast coaxial cables, fiber optic cables, satellite communications, cellular communications, and the like. In some examples, the network 108 may include any number of intermediate network devices, such as switches, routers, gateways, servers, and/or controllers, which are not directly part of the network infrastructure 102 but that facilitate communication between the various parts of the network infrastructure 102, and between the network infrastructure 102 and any other network-connected entities.

The network infrastructure 102 may be a small-scale network of devices or a large-scale network of devices. The small-scale network of devices may be a home network, for example. The large-scale network of devices may be an organization, university, public utility space (e.g., mall, airport, railway station, bus station, stadium, etc.), or office network hosting a large number of network devices, for example. The network infrastructure 102 may span across more than one site, for example, a room, a floor of a building, a building, or any other space that can host network devices. The network infrastructure 102 may be a private network, such as a network that may include security and access controls to restrict access to authorized users of the private network.

The network infrastructure 102 may include several devices that communicate with each other and/or with any external device or system outside the network infrastructure 102. In the example implementation depicted in FIG. 1, the network infrastructure 102 is shown to include a plurality of networking resources, such as, networking resources 106A, 106B, 106C, 106D, 106E, 106F, and 106G (hereinafter collectively referred to as networking resources 106A-106G); and one or more client devices (not shown). Client devices may include desktop computers, laptop computers, servers, web servers, authentication servers, authentication-authorization-accounting (AAA) servers, Domain Name System (DNS) servers, Dynamic Host Configuration Protocol (DHCP) servers, Internet Protocol (IP) servers, Virtual Private Network (VPN) servers, network policy servers, mainframes, tablet computers, e-readers, netbook computers, televisions and similar monitors (e.g., smart TVs), content receivers, set-top boxes, personal digital assistants (PDAs), mobile phones, smartphones, virtual terminals, video game consoles, virtual assistants, Internet-of-Things (IoT) devices, and the like.

A networking resource, for example, any of the networking resources 106A-106G, may be a combination of hardware, software, and/or firmware that is configured to provide wireless network connectivity to the client device. A networking resource may be a wireless networking device, for example, an access point (AP) that may be implemented with one or more radios to help the AP communicate with a client device and other wireless-capable devices. Each radio of the AP may operate on a respective range of radio frequency ranges, referred to as a Wi-Fi band, for example, the 2.4 GHz Wi-Fi band, 5 GHz Wi-Fi band, the 6 GHz Wi-Fi band, and so on.

Further, in some examples, one or more of the networking resources 106A-106G are multi-link devices (MLDs) that can support multi-link operation (MLO) in accordance with Wi-Fi standards, for example, Wi-Fi 7. MLO allows a Wi-Fi device (such as any of the capable the networking resources 106A-106G) to simultaneously use multiple frequency bands or channels for data transmission and reception. The primary goal of MLO is to increase throughput, reduce latency, and enhance the overall reliability and robustness of the Wi-Fi connection. By leveraging multiple links, MLO can dynamically balance the load, switch to the best available link, and mitigate interference, leading to a more efficient and stable network performance. Further, with the MLD enabled, a networking resource can establish and manage multiple links across different frequency bands (e.g., 2.4 GHz, 5 GHz, and 6 GHz), enabling it to take full advantage of MLO. This capability allows an MLD networking resource to offer better performance in terms of speed, latency, and reliability compared to traditional single-link devices.

In some example implementations, the networking resource may be a communication unit such as a radio within a wireless networking device (e.g., AP). For instance, the networking resources 106A, 106B, and 106C, may be radios within a single wireless networking device, whereas the networking resources 106D, 106E, 106F, and 106G may be separate wireless networking devices or radios within separate wireless networking devices. The networking resources 106A-106G may communicate with the client devices or with each other in accordance with one or more IEEE 802.11 standard specifications.

The networking resources 106A-106G may act as a point of access to a local network established in the network infrastructure 102 and/or the external network 108 for any client devices in the network infrastructure 102. For example, a client device may connect to any of the networking resources 106A-106G over a wireless communication link to communicate with other devices within or outside the network infrastructure 102. The wireless communication link may be established in compliance with any of the IEEE 802.11 Standards. Accordingly, a client device may communicate with any other devices (inside the network infrastructure 102 or outside the network infrastructure 102) via the respective networking resource.

Further, in some examples, the network infrastructure 102 may optionally include a local controller 110 that is in communication with the external network 108. It is to be noted that the examples presented herein are not limited by the specifics (e.g., types and counts) of the devices/networking resources depicted in FIG. 1. In some examples, the networking resources 106A-106G, the client devices, and/or the local controller 110 may be configured to communicate other devices using wired or wireless communication techniques.

The networking resources 106A, 106B, 106C, 106D, 106E, 106F, and 106G may communicate with the local controller 110 over respective connections, for example, the connections 112A, 112B, 112C, 112D, 112E, 112F, and 112G, which may include wired and/or wireless interfaces. The local controller 110 may provide communication with the network 108 for the network infrastructure 102, though it may not be the only point of communication with the network 108 for the network infrastructure 102.

In some examples, the local controller 110 may communicate with the network 108 through a router (not shown). In other implementations, the local controller 110 may provide router functionality to the devices in the network infrastructure 102. In some examples, the local controller 110 may be a wireless local area network (WLAN) controller. The local controller 110 may be operable to configure and manage the networking resources, such as at the network infrastructure 102, and may also manage network devices at other remote sites, if any, within the network infrastructure 102. The local controller 110 may be operable to configure and/or manage switches, routers, access points, and/or client devices. The local controller 110 may itself be, or provide the functionality of, an AP or the networking resources 106A-106G.

Certain networking resources may support time-sensitive networking that may enable various time-sensitive applications, such as video gaming, media streaming, automotive applications, etc. Factors such as variable transmission delays, interference, and mobility of networking nodes, may affect the high-precision time synchronization among the networking resources if the time synchronization among the participating networking resources is inaccurate. In examples consistent with the teachings of this disclosure, the proposed network controller 104 efficiently manages the time-synchronization among certain networking resources located in the network infrastructure 102 while reducing the overall time required for synchronization and improving available airtime for quality data communication.

The network controller 104 may be deployed in a public, private, or hybrid cloud outside the network infrastructure 102. In some examples, the network controller 104 may be implemented as one or more computing systems, for example, computers, controllers, servers, or storage systems. In certain examples, the network controller 104 may be an electronic device having a hardware processing resource, such as one or more central processing units (CPUs), semiconductor-based microprocessors, and/or other hardware devices suitable for retrieval and execution of instructions (e.g., time synchronization instructions 120). In certain other examples, the network controller 104 may be implemented as a software resource, such as a software application, a virtual machine (VM), a container, a containerized application, or a pod. In some examples, the network controller 104 may be implemented as a service running on a “cloud computing” environment or as a “software as a service” (SaaS). The network controller 104 and/or the functionalities implemented via the network controller 104 may be offered as a stand-alone product/service or a packaged solution that can be utilized on a one-time full product/solution purchase or pay-per-use basis.

In certain other examples, not shown in FIG. 1, the network controller 104 may be deployed within the network infrastructure 102. In such an implementation, the network controller 104 may be connected to the local controller 110 or the networking resources 106A-106G. In some other examples, the local controller 110 may itself be configured to implement the functionalities of the network controller 104.

In accordance with the examples presented herein, the network controller 104 may host a time synchronization system 118 by way of a processing resource executing the time synchronization instructions 120 stored in a machine-readable medium of the network controller 104. For illustration purposes, the time synchronization system 118 and the time synchronization instructions 120 are represented by the dashed outline as they represent digital entities which may be in the form of data and/or instructions that are executable by a physical processing resource, for example, a processor. By way of executing the time synchronization instructions 120, the time synchronization system 118 may create a network domain 114 comprising a set of candidate network resources (e.g., the candidate networking resources 106A-106E) that may benefit from precise time synchronization based on TSN demands of the set of candidate network resources 106A-106E.

In particular, to create the network domain 114, the network controller 104 may select a plurality of candidate networking resources from the networking resources 106A-106G based on respective TSN demands. In another example, the network controller 104 may create the network domain 114 by way of selecting an area within the network infrastructure 102 based on the TSN demands of the networking resources 106A-106G. A TSN demand may be determined based on one or more of a multi-access point (AP) coordination demand, a non-simultaneous transmit and receive (NSTR) demand, or a TSN demand. For illustration purposes, in FIG. 1, an example network domain 114 is marked with a dotted outline. As depicted in FIG. 1, the network domain 114 includes candidate networking resources 106A, 106B, 106C, 106D, and 106E, hereinafter collectively referred to as candidate networking resources 106A-106E.

Further, to synchronize timing among the candidate networking resources 106A-106E in the network domain 114, the network controller 104 may select a reference clock resource for the network domain 114. The reference clock resource may serve as a time reference for the rest of the candidate networking resources in the network domain 114. While one of the candidate resources is selected as the reference clock resource, the remaining candidate resources (i.e., the candidate resources other than the reference clock resource) in the network domain 114 are referred to as affiliate networking resources.

The reference clock resource may be selected from the candidate networking resources 106A-106E based on the respective time-synchronization capabilities. Examples of the time-synchronization capabilities that the network controller 104 may use to select the reference clock resource may include, one or more of the presence of a predefined clock resource (e.g., a high precision clock such as an atomic clock), a presence of Global Positioning System (GPS) receiver with the candidate networking resource, a ranging capability (e.g., FTM capability), or a multi-link device (MLD) capability. For illustration purposes, in the present disclosure, various examples are described with reference to the MLD capability as the time-synchronization capability. Accordingly, in one example, the network controller may select a candidate networking resource that is capable of being operable as a Main AP in an MLD configuration (e.g., a standard MLD configuration or a unified MLD configuration) as the reference clock resource. For instance, if the candidate networking resource 106A is operable as the MAP in the MLD configuration, the candidate networking resource 106A may be selected as the reference clock resource, and the rest of the candidate networking resources 106B-106E are designated as affiliate networking resources. Table 1 presented below depicts an example classification of the candidate networking resources 106A-106E of the network domain 114.

TABLE 1
Example classification of candidate networking resources

| Candidate Networking | |
|---|---|
| Resource | Classification |
| 106A | Clock Reference Resource |
| 106B | Affiliate Networking Resource |
| 106C | Affiliate Networking Resource |
| 106D | Affiliate Networking Resource |
| 106E | Affiliate Networking Resource |

In certain other examples, the network controller 104 may assign a clock priority to the candidate networking resources 106A-106E based on the respective time-synchronization capabilities and use such clock priorities to select a particular networking resource of the candidate networking resources 106A-106E as the reference clock resource. Furthermore, in some examples, the network controller 104 may time synchronize the affiliate networking resources 106B-106E with the reference clock resource using predefined network delays between the reference clock resource and each of the affiliate networking resources 106B-106E.

In some examples, the reference clock resource might have pre-calculated the network delays between the reference clock resource and each of the affiliate networking resources 106B-106E by performing one or more ranging operations (e.g., FTM or RTT measurements) in compliance with IEEE 802.11 Standard Specifications. The term network delay between the reference clock resource and a given affiliate networking resource may refer to a time that a signal (e.g., a frame) takes to travel from the reference clock resource to the given affiliate networking resource, or vice-versa. It may be noted that the network controller utilizes these pre-calculated network delays to time-synchronize the affiliate networking resources 106B-106E with the clock reference resource 106A. As a result, unlike the existing time-synchronization techniques such as Precision Time Protocol (PTP) and generalized PTP (gPTP) that entail re-calculating a delay between each device pair (e.g., a designated reference clock resource and the other networking device in the PTP/gPTP process), the proposed time synchronization by the network controller 104 saves significant time by using the already available/precalculated network delay values (i.e., the predefined network delay). Furthermore, the reference clock resource (e.g., the network controller 104) is configured to be used as a main-AP (MAP) of the MLD to time-synchronize the rest of the affiliate networking resources 106B-106E with the clock reference resource 106A simultaneously, thereby saving another considerable time that the traditional PTP and gPTP techniques may spend in time-synchronizing each device pair individually.

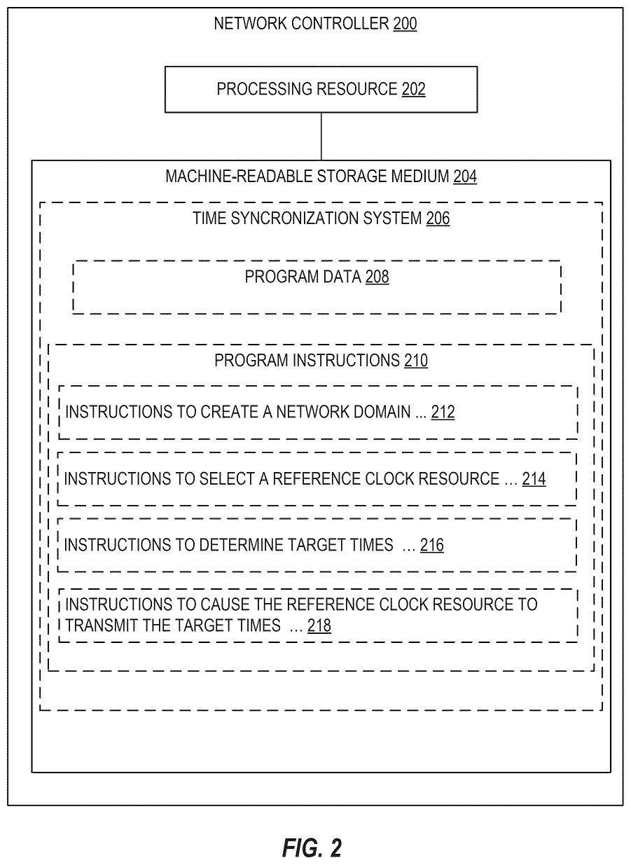

Additional details about the process of time-synchronization by the network controller 104 are described in conjunction with the block diagrams and flow diagrams of FIGS. 2-4.

Referring to FIG. 2, a block diagram of an example network controller 200 is presented. The network controller 200 of FIG. 2 may be an example representative of the network controller 104 of FIG. 1. In certain other examples, the network controller 200 may be implemented as a controller, such as the local controller 110 deployed within the network infrastructure 102 of FIG. 1. In particular, the network controller 200 is configured with a time synchronization system 206 to aid in time-synchronizing networking resources, such as the networking resources 106A-106G within the network infrastructure 102 of FIG. 1. For illustration purposes, the time synchronization system 206 and items inside the time synchronization system 206 are represented by the dashed outline as they represent digital entities which may be in the form of data and/or instructions that are executable by a physical processing resource, for example, the processing resource 202.

The network controller 200 may include a processing resource 202 and/or a machine-readable storage medium 204 for the network controller 200 to execute several operations as will be described in the greater details below.

The processing resource 202 may be a physical device, for example, a central processing unit (CPU), a microprocessor, a graphics processing unit (GPU), a field-programmable gate array (FPGA), application-specific integrated circuit (ASIC), other hardware devices capable of retrieving and executing instructions stored in the machine-readable storage medium 204, or combinations thereof. In one example, the processing resource 202 may fetch, decode, and execute the instructions stored in the machine-readable storage medium 204 to aid in time-synchronizing networking resources, such as the networking resources 106A-106G within the network infrastructure 102 of FIG. 1. As an alternative or in addition to executing the instructions, the processing resource 202 may include at least one integrated circuit (IC), control logic, electronic circuits, or combinations thereof that include a number of electronic components for performing the functionalities intended to be performed by the network controller 200.

The machine-readable storage medium 204 may be non-transitory and is alternatively referred to as a non-transitory machine-readable storage medium that does not encompass transitory propagating signals. The machine-readable storage medium 204 may be any electronic, magnetic, optical, or another type of storage device that may store data and/or executable instructions. Examples of the machine-readable storage medium 204 may include Random Access Memory (RAM), Non-volatile random-access memory (NVRAM), Electrically Erasable Programmable Read-Only Memory (EEPROM), a storage drive (e.g., Solid-State Drive or Hard Disk Drive), a flash memory device, and the like. The machine-readable storage medium 204 may be encoded with the time synchronization system 206 which aid in time-synchronizing networking resources, such as the networking resources 106A-106G within the network infrastructure 102 of FIG. 1. The time synchronization system 206 includes program data 208 and program instructions 210 to manage the roaming of the client devices.

The program data 208 may store a variety of data that may be received, used, and/or generated by the processing resource 202 as the processing resource 202 executes the program instructions 210. In some examples, the program data 208 may store a configuration repository that includes network configuration data about the networking resources in the network infrastructure. The network configuration data may include specifics about the wireless communication features, such as, but not limited to, a multi-AP coordination requirement, MLD NSTR, TSN, and the like, that the networking resource is configured with. Further, the configuration repository may also store the network configuration data about features such as a MAP capability, a ranging capability (e.g., FTM to RTT), Global Positioning system (GPS) capability, or having high-precision clock corresponding to the networking resources. The processing resource may use this configuration data to create a network domain such as the network domain 114 and to select a reference clock resource for the network domain 114.

The multi-AP coordination requirement is a feature of Wi-Fi 8 that enables a joint transmission to the client device, wherein a plurality of networking resources may participate in transmitting data to the client device. Such a joint transmission may benefit from the enhanced time-synchronization among the networking resources. Further, the MLD NSTR feature is a mode of operation within the MLD framework wherein a Wi-Fi device (e.g., a networking resource) can use multiple links for communication, but it does not simultaneously transmit and receive via these links. Instead, the Wi-Fi device may switch between links for transmission and reception in a time-division manner. Overall, the MLD NSTR feature in Wi-Fi 8 aims to provide a more robust and efficient wireless communication experience by intelligently managing and utilizing multiple frequency channels without the need for simultaneous transmission and reception on those channels. Accordingly, if enabled, the MLD NSTR feature requires the participating devices in the MLD NSTR to be time-synchronized. Furthermore, the TSN wireless network synchronization requirements such as the execution of virtual reality games need highly precise time-synchronization requirements among different Wi-Fi devices that participate in these games.

Further, the MAP capability of an MLD is an enhancement introduced with the IEEE 802.11be standard, commonly known as Wi-Fi 7. This capability is designed to improve the coordination and performance of Wi-Fi networks by allowing multiple networking resources to work together more efficiently. The ranging techniques such as FTM and RTT are used by the networking resources to enable accurate distance measurement between two networking resources.

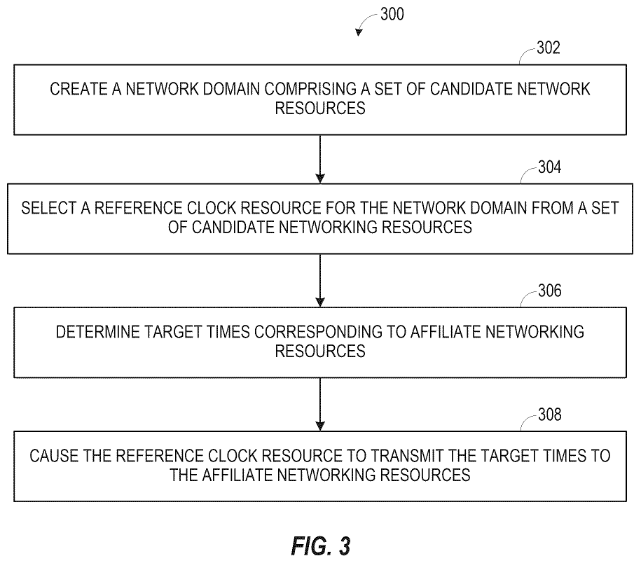

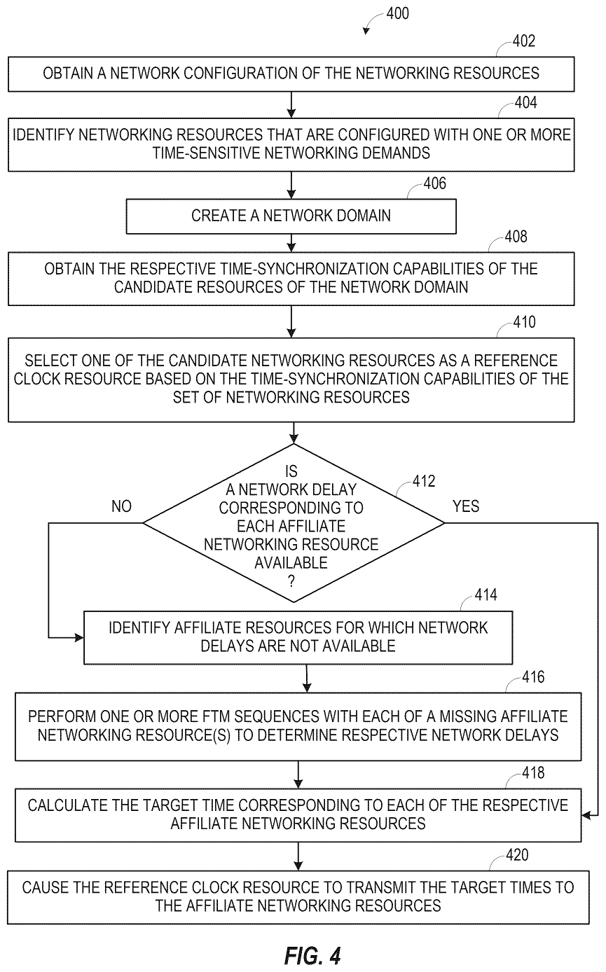

In accordance with examples consistent with the present disclosure, the network controller 200 may execute the time synchronization system 206, by way of the processing resource 202 executing the program instructions 210, to aid in time-synchronizing networking resources. In particular, in some examples, the processing resource 202 may execute one or more of the program instructions 210 to perform the method steps described in conjunction with FIGS. 3 and 4. For example, the program instructions 210 may include instructions 212, 214, 216, and 218.

In particular, the instructions 212 when executed by the processing resource 202 may cause the processing resource 202 to create a network domain (e.g., the network domain 114 of FIG. 1) comprising a set of candidate network resources (e.g., the candidate network resources 106A-106E) based on a TSN demand of the set of candidate network resources. Further, the instructions 214, when executed by the processing resource 202, may cause the processing resource 202 to select a reference clock resource for the network domain from a set of candidate networking resources based on time-synchronization capabilities of the set of candidate networking resources. By way of example, the candidate networking resource 106A may be selected as the reference clock resource based on its time-synchronization capabilities. The candidate networking resources other than the reference clock resource may be referred to as affiliate networking resources (e.g., the networking resources 106B-106E).

Furthermore, the instructions 216, when executed by the processing resource 202, may cause the processing resource 202 to determine target times corresponding to affiliate networking resources based on respective predefined network delays relative to the reference clock resource, wherein the affiliate networking resources are candidate networking resources of the network domain other than the reference clock resource. Moreover, the instructions 218, when executed by the processing resource 202, may cause the processing resource 202 to cause the reference clock resource to transmit the target times to the affiliate networking resources.

Although not shown, in some examples, the machine-readable storage medium 204 may be encoded with certain additional executable instructions to perform any other operations performed by the network controller 200, without limiting the scope of the present disclosure.

Turning now to FIGS. 3 and 4, flowcharts of example methods for time synchronizing networking resources are presented. The steps shown in FIGS. 3 and 4 may be performed by any suitable device, such as a network controller 104 or the local controller 110 shown in FIG. 1, or the network device 200 of FIG. 2. In some examples, the suitable device may include a processing resource suitable for retrieval and execution of instructions stored in a machine-readable storage medium. The processing resource and the machine-readable storage medium may be example representatives of the processing resource 202 and the machine-readable storage medium 204 of the network device 200. As an alternative or in addition to retrieving and executing instructions, the processing resource may include one or more electronic circuits that include electronic components for performing the functionality of one or more instructions, such as an FPGA, ASIC, or other electronic circuits.

FIG. 3 depicts an example method 300 for time synchronizing networking resources (e.g., the networking resources 106A-106G of FIG. 1) in a network infrastructure (e.g., the network infrastructure 102 of FIG. 1) is presented.

At step 302, the network controller (e.g., the network controller 104 or 200) may create a network domain (e.g., the network domain 114) comprising a set of candidate network resources based on a respective TSN demand. The TSN demand may refer to a wireless communication feature of a networking resource that may benefit from enhanced time synchronization with other networking resources. To aid in the selection of the network domain that benefits from enhanced time-synchronization, the network controller may maintain a configuration repository that stores network configuration data about all of the networking resources in the network infrastructure. The network configuration data may include specifics about the wireless communication features, for example, a multi-AP coordination requirement, MLD NSTR, TSN, and the like, that the networking resource is configured with.

Accordingly, at step 302, the network controller may access the configuration repository to ascertain if one or more networking resources of the network infrastructure are configured with such TSN demands (e.g., multi-AP coordination, MLD NSTR, TSN, etc.). In one example, the network controller may categorize all the networking devices that are configured with one or more TSN demands into one group, referred to as the network domain. In some other cases, the network domain may be defined as a region within the network infrastructure that includes networking resources configured with one or more time-sensitive networking demands. The networking resources that are part of the network domain created at step 302 are referred to as candidate networking resources. By way of example, as described in conjunction with FIG. 1, the network domain 114 may include candidate networking resources 106A-106E that are selected from the plurality of networking resources 106A-106G.

After the network domain is created, at step 304, the network controller may select a reference clock resource for the network domain from the set of candidate networking resources based on respective time-synchronization capabilities. To select the reference clock resource, the network controller may again check the configuration of each of the set of candidate networking resources of the network domain to identify one or more networking resources that may satisfy clock selection criteria.

In one example, the clock selection criteria may require a candidate networking resource to be capable of being operated as a main AP (MAP) in an MLD configuration. If more than one candidate networking resources are identified as capable of being operated as MAP, the network controller may further narrow down the list of the candidate networking resources based on other sub-criteria such as a ranging capability, for example, RTT or FTM. For example, if three candidate networking resources are identified as capable of being operated as the MAP in an MLD configuration, one or more candidate networking resources that are capable of performing FTM may be selected. if the resulting number of candidate networking resources that satisfy both the above-listed criteria is more than one, the network controller may apply yet another sub-criteria that requires the candidate networking resource to include a high-precision clock source, such as an atomic clock or a GPS receiver. Accordingly, in one example, a candidate networking resource that is capable of being operated as the MAP in the MLD configuration, capable of performing the FTM, and comprising the high-precision clock may be selected as the reference clock resource for the network domain.

In some other example implementations, the network controller may assign a clock priority to each of the set of candidate networking resources based on the respective time-synchronization capabilities such as the MAP capability in the MLD configuration, the FTM capability, and the presence of the high-precision clock. For instance, the network controller may assign a priory value in decreasing order of the number of time-synchronization capabilities that the candidate networking resource may possess. That is, the candidate networking resource having the highest number of time-synchronization capabilities may be assigned the highest clock priority and the candidate networking resource having the lowest number of time-synchronization capabilities may be assigned the lowest clock priority. Finally, the network controller may select the candidate networking resource that has the highest clock priority as the reference clock resource. The candidate networking resources other than the reference clock resource are referred to as affiliate networking resources.

Furthermore, after the reference clock resource is identified, the network controller may begin synchronizing the affiliate networking resources in the network domain with the reference clock resource. In this process of time-synchronization, at step 306, the network controller may determine target times corresponding to affiliate networking resources based on respective predefined network delays relative to the reference clock resource.

In some examples, the reference clock resource would have pre-calculated the network delays for each of the affiliate networking resources ahead of initiating the method 300 of FIG. 3, for example, by executing one or more ranging techniques, such as FTM. As it is understood, an FTM sequence allows a Wi-Fi device (e.g., any of the networking resources) to measure its distance from another Wi-Fi-enabled device with high precision by calculating the round-trip time of signals. The FTM sequence begins with the initiating device, known as the FTM Responder (e.g., the reference clock resource selected at step 304), sending a series of FTM request frames to the FTM Initiator (e.g., an affiliate networking resource). These request frames contain timestamps indicating the exact time they were sent. Upon receiving these frames, the FTM Initiator records the timestamps and then sends FTM response frames back to the FTM Responder, also timestamped with the precise time of transmission. The FTM Responder then calculates the round-trip time by comparing the timestamps of the sent and received frames. This process involves the exchange of multiple frames to ensure accuracy and compensate for any potential timing variations or delays.

The network delay between the reference clock resource and a given affiliate networking resource is the time a frame takes to travel from the reference clock resource to the affiliate networking device, or vice-versa. By way of example, the network delay may be a time equal to half of a round-trip time (RTT) between the reference clock resource and the given affiliate networking device. Such a pre-calculated network delay between the reference clock resource and the given affiliate networking device is referred to as the predefined network delay between the reference clock resource and the given affiliate networking resource. In one example, the predefined network delay (ND1) between the reference clock resource (e.g., the networking resource 106A) and an affiliate networking resource (e.g., the networking resource 106B) may be represented using an example relationship of Equation (1).

$$N D 1 = \frac{R T T 1}{2} \qquad Equation ( 1 )$$

wherein RTT1 represents the round-trip time between the networking resource 106A and the networking resource 106B.

In some examples, the reference clock resource might have precalculated the network delays corresponding to the rest of the affiliate resources in the network domain selected at step 302. For the example implementation of FIG. 1, wherein the network domain 114 includes five candidate networking resources 106A-106E, Table 2 presented below depicts respective predefined network delays from the reference clock resource (e.g., the networking resource 106A).

TABLE 2
Example precalculated network delays

| | RTT from Reference | |
|---|---|---|
| | clock resource (e.g., | |
| Affiliate networking | Networking Resource | Predefined Network |
| Resource | 106A) | Delay |
| Networking Resource 106B | RTT1 | $ND 1 = \frac{RTT 1}{2}$ |
| Networking Resource 106C | RTT2 | $ND 2 = \frac{RTT 2}{2}$ |
| Networking Resource 106D | RTT3 | $ND 3 = \frac{RTT 3}{2}$ |
| Networking Resource 106E | RTT4 | $ND 4 = \frac{RTT 4}{2}$ |

As a result, unlike the existing time-synchronization techniques such as Precision Time Protocol (PTP) and generalized PTP (gPTP) that entail re-calculating a delay between each device pair (e.g., a designated reference clock resource and the other networking device in the PTP/gPTP process), the proposed time synchronization by the network controller saves significant time by using the already available/precalculated delay values (i.e., the predefined network delay).

Periodically or after the predefined network delays are calculated by the reference clock resource, the network controller may obtain predefined network delays from the reference clock resource, and store them in program data (e.g., the program data 208, see FIG. 2) ahead of executing the method 300 of FIG. 3. Accordingly, during the execution of the method 300, in particular at step 306, the network controller may use such predefined network delays to time-synchronize the affiliate networking resources with the reference clock resource.

Based on the predefined network delays, the network controller may determine the target times for the affiliate networking resources. In one example, for a given affiliate networking resource, the network controller may calculate a target time by adding the predefined time delay corresponding to the given affiliate networking resource a current time at the reference clock resource. In one example, the target time (TT1) corresponding to an affiliate networking resource (e.g., the networking resource 106B) may be represented using an example relationship of Equation (2).

$$T T 1 = {T}_{CURRENT} + N D 1 \qquad Equation ( 2 )$$

Wherein T_{CURRENT} represents the current time at the reference clock resource.

Likewise, provided the network controller has already precalculated its network delay corresponding to each of the affiliate networking resources in the network domain, the network controller may determine respective target times by adding the respective predefined network delays to the current time at the reference clock resource. Table 3 presented below depicts target times for each of the affiliate networking resources in the network domain 114 of FIG. 1.

TABLE 3
Example target times.

| Affiliate networking | | |
|---|---|---|
| Resource | Network Delay | Target Time |
| Networking Resource | ND1 | TT1 = T_{CURRENT} + ND1 |
| 106B | | |
| Networking Resource | ND2 | TT2 = T_{CURRENT} + ND2 |
| 106C | | |
| Networking Resource | ND3 | TT3 = T_{CURRENT} + ND3 |
| 106D | | |
| Networking Resource | ND4 | TT4 = T_{CURRENT} + ND4 |
| 106E | | |

In the event that the reference clock resource does not have the network delay precalculated for any of the affiliate networking resources in the network domain, the reference clock resource may initiate an FTM sequence with such affiliate networking resource to determine the respective round-trip time, network delay, and the target time.

Further, at step 308, the network controller may cause the reference clock resource to transmit the target times (determined at step 306) to the affiliate networking resources of the network domain. In particular, the network controller may instruct the reference clock resource to transmit the target time to all the rest of the affiliate networking resources in the network domain at once. In some examples, the reference clock resource may use its capability of being the Main AP (AP) in the MLD configuration to transmit the target time simultaneously to all affiliate networking resources in the network domain.

Referring to FIG. 4, a flowchart of another example method 400 for aiding the time synchronization among the networking resources in a network infrastructure (e.g., the network infrastructure 102 of FIG. 1) is presented. The method 400 of FIG. 4 may include certain additional steps and or information compared to the method 300 of FIG. 3. Also, certain details of the steps that are already described in FIG. 4 are not repeated herein for the sake of brevity. Further, for illustration purposes, the method 400 is described in conjunction with the networked system 100 of FIG. 1.

At step 402, the network controller (e.g., the network controller 104) may obtain a network configuration of the networking resources (e.g., the networking resources 106A-106G). As previously noted, the network controller maintains a configuration repository (for example, in the program data 208 stored in the machine-readable storage medium 204 of FIG. 2) that stores network configuration data about all of the networking resources in the network infrastructure. For each of the networking resources, the network configuration data may include specifics about the TSN demands specified via wireless communication features, such as a multi-AP coordination requirement, MLD NSTR requirement, TSN requirement, and the like, that the networking resource is configured with.

Further, at step 404, the network controller may identify networking resources that are configured with one or more time-sensitive networking demands. The network controller may review the network configuration data of each of the networking resources to find a match for any of the time-sensitive networking demands such as the multi-AP coordination requirement, the MLD NSTR requirement, the TSN requirement, and the like. The networking resources that are configured with one or more of such time-sensitive networking demands may be identified as networking resources that may benefit from enhanced time synchronization.

Furthermore, at step 406, the network controller may create a network domain comprising the networking resources identified at step 404 based on the respective time-sensitive networking demands. For example, as depicted in FIG. 1, from the networking resource 106A-106G, the set of networking resources 106A-106E is identified as demanding time-sensitive networking. These networking resources forming the network domain are referred to as the candidate networking resources. Accordingly, the network controller creates the network domain 114 comprising the candidate networking resources 106A-106E.

At step 408, the network controller (e.g., the network controller 104) may access the network configuration of the set of networking resources (e.g., the candidate networking resources 106A-106E) to obtain the respective time-synchronization capabilities of the candidate resources of the network domain. The time-synchronization capabilities may include a MAP in the MLD configuration, FTM capability, and availability of a high-precision clock source. Further, at step 410, the network controller may select one of the candidate networking resources as a reference clock resource based on the time-synchronization capabilities of the set of networking resources. Example techniques of selecting the reference clock resource are described in conjunction with the method 300 of FIG. 3. By way of example, if the candidate networking resource 106A is capable of being operated as the MAP in the MLD configuration, the candidate networking resource having the FTM capability, and the candidate networking resource having the high-precision clock source (e.g., an atomic clock or GPS receiver), the network controller may select networking resource 106A as the reference clock resource and the rest of the networking resources (e.g., the networking resources 106B-106E) of the network domain 114 may be designated as the affiliate networking resources.

Further, it may be noted that the FTM-capable reference clock resource might have performed one or more FTM sequences with some or all of the affiliate networking resources. Accordingly, the reference clock resource would have already determined the network delays between the reference clock resource and each of the affiliate networking resources. However, to ensure that the reference clock resource has the network delay calculated corresponding to each of the affiliate networking resources, the reference clock resource, at step 412, may perform a check to determine if the network delay corresponding to each affiliate networking resource is available. At step 412, if it is determined that the network delay corresponding to each affiliate networking resource is not available, the network controller, at step 414, may identify the affiliate networking resource(s) for which the network delay is not calculated (hereinafter referred to as missing affiliate networking resource(s)).

Then, at step 416, the reference clock resource may perform one or more FTM sequences in accordance with IEEE 802.11 Standard Specifications with each of the missing affiliate networking resource(s) to determine respective network delays. In general, as previously noted, an FTM sequence begins with the initiating device, known as the FTM Responder (e.g., the reference clock resource), sending a series of FTM request frames to the FTM Initiator (e.g., a missing affiliate networking resource). These request frames contain timestamps indicating the exact time they were sent. Upon receiving these frames, the FTM Initiator records the timestamps and then sends FTM response frames back to the FTM Responder, also timestamped with the precise time of transmission. The FTM Responder then calculates the round-trip time (RTT) by comparing the timestamps of the sent and received frames. Such FTM sequence may be performed for all of the missing affiliate networking resources and the RTT corresponding to each may be calculated. Then, for each missing affiliate networking resource, the network delay may be calculated by dividing the respective RTT value by 2. Accordingly, at the end of step 416, the reference clock resource has the network delay available for each of the affiliate networking resources in the network domain.

At step 412, if it is determined that the network delay corresponding to each affiliate networking resource is available, the network controller, may skip steps 414-416 and move the execution to step 418. Alternatively, after completion of the execution of step 416, the network controller may execute step 418. In particular, at step 418, the reference clock resource may calculate the target time corresponding to each of the respective affiliate networking resources by adding the respective network delays to the current time at the reference clock resource. Table 3 presented above depicts target times for each of the affiliate networking resources in the network domain 114 of FIG. 1.

Further, at step 420, the network controller may cause the reference clock resource to transmit the target time to each of the affiliate networking resources. In particular, the network controller may instruct the reference clock resource to transmit the target time to all the affiliate networking resources at once. In some examples, the reference clock resource may use its capability of being the Main AP (AP) in the MLD configuration to transmit the target time simultaneously to all affiliate networking resources in the network domain.

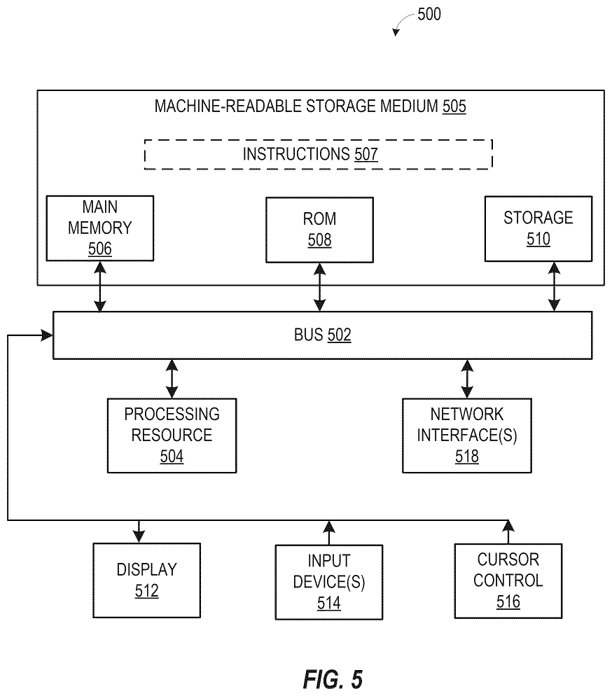

FIG. 5 depicts a block diagram of an example computing system 500 in which various of the examples described herein may be implemented. In one example, the computing system 500 may be configured to operate as a network controller such as the network controller 104 of FIG. 1 and can perform various operations described in one or more of the earlier drawings. In another example, the computing system 500 may be any system in a could infrastructure and capable of hosting a time synchronization system described earlier. Examples of the devices and/or systems that may be implemented as the computing system 500 may include, desktop computers, laptop computers, servers, web servers, authentication servers, AAA servers, DNS servers, DHCP servers, IP servers, VPN servers, network policy servers, mainframes, tablet computers, e-readers, netbook computers, televisions and similar monitors (e.g., smart TVs), content receivers, set-top boxes, PDAs, mobile phones, smartphones, smart terminals, dumb terminals, virtual terminals, video game consoles, virtual assistants, IoT devices, and the like.

The computing system 500 may include a bus 502 or other communication mechanisms for communicating information, a hardware processor, also referred to as processing resource 504, and a machine-readable storage medium 505 coupled to the bus 502 for processing information. In some examples, the processing resource 504 may include one or more CPUs, semiconductor-based microprocessors, and/or other hardware devices suitable for retrieval and execution of instructions stored in the machine-readable storage medium 505. The processing resource 504 may fetch, decode, and execute instructions to time synchronize a plurality of networking resources in a network infrastructure, such as the network infrastructure 102 depicted in FIG. 1. As an alternative or in addition to retrieving and executing instructions, the processing resource 504 may include one or more electronic circuits that include electronic components for performing the functionality of one or more instructions, such as an FPGA, an ASIC, or other electronic circuits.

In some examples, the machine-readable storage medium 505 may include a main memory 506, such as a RAM, cache, and/or other dynamic storage devices, coupled to the bus 502 for storing information and instructions to be executed by the processing resource 504. The main memory 506 may also be used for storing temporary variables or other intermediate information during the execution of instructions to be executed by the processing resource 504. Such instructions, when stored in storage media accessible to the processing resource 504, render the computing system 500 into a special-purpose machine that is customized to perform the operations specified in the instructions. The machine-readable storage medium 505 may further include a read-only memory (ROM) 508 or other static storage device coupled to the bus 502 for storing static information and instructions for the processing resource 504. Further, in the machine-readable storage medium 505, a storage device 510, such as a magnetic disk, optical disk, or USB thumb drive (Flash drive), etc., may be provided and coupled to the bus 502 for storing information and instructions.

In some examples, the bus 502 of the computing system 500 may be coupled to a display 512, such as a liquid crystal display (LCD) (or touch-sensitive screen), for displaying information to a computer user. In some examples, an input device 514, including alphanumeric and other keys (physical or software generated and displayed on a touch-sensitive screen), may be coupled to the bus 502 for communicating information and command selections to the processing resource 504. Also, in some examples, another type of user input device such as a cursor control 516 may be connected to the bus 502. The cursor control 516 may be a mouse, a trackball, or cursor direction keys. The cursor control 516 may communicate direction information and command selections to the processing resource 504 for controlling cursor movement on the display 512. In some other examples, the same direction information and command selections as cursor control may be implemented via receiving touches on a touch screen without a cursor.

In some examples, the computing system 500 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

The computing system 500 also includes a network interface 518 coupled to bus 502. The network interface 518 provides a two-way data communication coupling to one or more network links that are connected to one or more local networks. For example, the network interface 518 may be an integrated services digital network (ISDN) card, cable modem, satellite modem, or a modem to provide a data communication connection to a corresponding type of telephone line. As another example, the network interface 518 may be a local area network (LAN) card or a wireless communication unit (e.g., Wi-Fi chip/module).

In some examples, the machine-readable storage medium 505 (e.g., one or more of the main memory 506, the ROM 508, or the storage device 510) stores instructions 507 (marked with dashed outline) which when executed by the processing resource 504 may cause the processing resource 504 to execute one or more of the methods/operations described hereinabove. The instructions 507 may be stored on any of the main memory 506, the ROM 508, or the storage device 510. In some examples, the instructions 507 may be distributed across one or more of the main memory 506, the ROM 508, or the storage device 510. In some examples, the instructions 507 when executed by the processing resource 504 may cause the processing resource 504 to perform one or more of the methods described in any of FIGS. 3 and 4.

Terms and phrases used in this document, and variations thereof, unless otherwise expressly stated, should be construed as open-ended as opposed to limiting. As examples of the foregoing, the term “including” should be read as meaning “including, without limitation” or the like. The term “example” is used to provide exemplary instances of the item in the discussion, not an exhaustive or limiting list thereof. The terms “a” or “an” should be read as meaning “at least one,” “one or more” or the like. The presence of broadening words and phrases such as “one or more,” “at least,” “but not limited to” or other like phrases in some instances shall not be read to mean that the narrower case is intended or required in instances where such broadening phrases may be absent. Further, the term “and/or” as used herein refers to and encompasses any and all possible combinations of the associated listed items. It will also be understood that, although the terms first, second, third, etc., may be used herein to describe various elements, these elements should not be limited by these terms, as these terms are only used to distinguish one element from another unless stated otherwise or the context indicates otherwise.

What is claimed is:

1. A method comprising:
creating a network domain comprising a set of candidate network resources based on a time-sensitive networking demand of the set of candidate network resources;
selecting a reference clock resource for the network domain from a set of candidate networking resources based on time-synchronization capabilities of the set of candidate networking resources;
determining target times corresponding to affiliate networking resources based on respective predefined network delays relative to the reference clock resource, wherein the affiliate networking resources are candidate networking resources of the network domain other than the reference clock resource; and
causing the reference clock resource to transmit the target times to the affiliate networking resources.

2. The method of claim 1, wherein creating the network domain comprises selecting the set of candidate network resources from a plurality of network resources located in network infrastructure.

3. The method of claim 1, wherein the time-sensitive networking demand comprises one or more of a multi-access point (AP) coordination demand, a non-simultaneous transmit and receive (NSTR) demand or a time-sensitive networking demand.

4. The method of claim 1, wherein the time-synchronization capabilities comprise one or more of a presence of a predefined clock resource, a ranging capability, or a multi-link device (MLD) capability.

5. The method of claim 4, wherein the predefined clock resource comprises one or more of a global positioning system (GPS) receiver, the ranging capability comprises a fine timing measurement (FTM) capability, and the MLD capability comprises operability in a main access point (MAP) in MLD.

6. The method of claim 1, wherein the predefined network delays had been calculated by the reference clock resource based on one or more FTM sequences.

7. The method of claim 1, wherein determining the target times comprises:
determining whether a network delay corresponding to an affiliated resource of the affiliate networking resources relative to the reference clock resource is unavailable;
calculating the network delay for the affiliate networking resource relative to the reference clock resource using a ranging technique; and
calculate a target time for the affiliate networking resource based on a current time at the reference clock resource and the network delay for the affiliate networking resource.

8. The method of claim 7, wherein the ranging technique comprises an FTM.

9. The method of claim 1, wherein the reference clock resource is MLD capable and is configured as a MAP in MLD in accordance with the Institute of Electrical and Electronics Engineers (IEEE) 802.11be standard specification.

10. The method of claim 1, wherein the reference clock resource is configured to transmit the target times simultaneously to all of the affiliate networking resources.

11. A network controller comprising:
a machine-readable storage medium storing executable instructions; and
a processing resource connected to the machine-readable storage medium and configured to execute one or more of the instructions to:
create a network domain comprising a set of candidate network resources based on a time-sensitive networking demand of the set of candidate network resources;
select a reference clock resource for the network domain from a set of candidate networking resources based on time-synchronization capabilities of the set of candidate networking resources;
determine target times corresponding to affiliate networking resources based on respective predefined network delays relative to the reference clock resource, wherein the affiliate networking resources are candidate networking resources of the network domain other than the reference clock resource; and
cause the reference clock resource to transmit the target times to the affiliate networking resources.

12. The network controller of claim 11, wherein the time-sensitive networking demand comprises one or more of a multi-access point (AP) coordination demand, a non-simultaneous transmit and receive (NSTR) demand, or a time-sensitive networking demand.

13. The network controller of claim 11, wherein the time-synchronization capabilities comprise one or more of a presence of a predefined clock resource, a ranging capability, or a multi-link device (MLD) capability.

14. The network controller of claim 11, wherein the predefined network delays had been calculated by the reference clock resource based on one or more FTM sequences.

15. The network controller of claim 11, wherein to determine the target times, the processing resource is configured to execute one or more of the instructions to:
determine whether a network delay corresponding to an affiliated resource of the affiliate networking resources relative to the reference clock resource is unavailable;
calculate the network delay for the affiliate networking resource relative to the reference clock resource using a ranging technique; and
calculate a target time for the affiliate networking resource based on a current time at the reference clock resource and the network delay for the affiliate networking resource.

16. The network controller of claim 15, wherein the ranging technique comprises an FTM.

17. The network controller of claim 11, wherein the reference clock resource is configured to transmit the target times simultaneously to all of the affiliate networking resources.

18. A non-transitory machine-readable medium storing instructions executable by a processing resource, the instructions comprising:
instructions to create a network domain comprising a set of candidate network resources based on a time-sensitive networking demand of the set of candidate network resources;
instructions to select a reference clock resource for the network domain from a set of candidate networking resources based on time-synchronization capabilities of the set of candidate networking resources;
instructions to determine target times corresponding to affiliate networking resources based on respective predefined network delays relative to the reference clock resource, wherein the affiliate networking resources are candidate networking resources of the network domain other than the reference clock resource; and
instructions to cause the reference clock resource to transmit the target times simultaneously to all of the affiliate networking resources while operating as a Main Access Point (MAP) in a Multi-Link-Device (MLD) configuration.

19. The non-transitory machine-readable medium of claim 18, wherein network controller of claim 11, wherein the time-sensitive networking demand comprises one or more of a multi-access point (AP) coordination demand, a non-simultaneous transmit and receive (NSTR) demand, or a time-sensitive networking demand, and wherein the time-synchronization capabilities comprise an MLD capability.

20. The non-transitory machine-readable medium of claim 18, further comprising instructions which when executed by the processing resource cause the processing resource to enable the reference clock resource to:
determine whether a network delay corresponding to an affiliated resource of the affiliate networking resources relative to the reference clock resource is unavailable;
calculate the network delay for the affiliate networking resource relative to the reference clock resource using a ranging technique; and
calculate a target time for the affiliate networking resource based on a current time at the reference clock resource and the network delay for the affiliate networking resource.
